(19) United States
(12) Patent Application Publication
(10) Pub. No.: US 2006/0093820 A1
(43) Pub. Date: May 4, 2006

(54) Functionalized nonwovens, method for production and use thereof

(75) Inventors: Kristina Margarit-Puri, Gorxheimertal (DE); Birgit Severich, Mannheim (DE); Gerhard Schoepping, Hemsbach (DE); Klaus Rodemann, Essen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/178,762

(22) Filed: Jul. 11, 2005

(30) Foreign Application Priority Data
Jul. 9, 2004 (DE) DE 10 2004 033 19

(51) Int. Cl. B32B 27/04; B32B 27/02; D04H 1/00; B32B 19/00; D02G 3/00; F16J 15/20; D04H 1/56; D04H 3/16; B05D 1/08; H05H 1/00

(52) U.S. Cl. 428/365; 442/63; 442/164; 442/357; 442/400; 442/401; 428/357; 428/364; 427/446; 427/533

(57) ABSTRACT

Functionalized nonwovens having a negative zeta potential in the pH range from 1 to 13 include fibers having a surface layer or surface regions applied by plasma treatment having anionic groups covalently bonded to the fiber surface and/or having precursors convertible into anionic groups and/or having polyether groups and/or polyol groups. The nonwovens may be used as filter materials or separation materials.

Priority is claimed to German Patent Application No. DE 10 2004 033 196.0, filed on Jul. 9, 2004, the entire disclosure of which is incorporated by reference herein.

The present invention relates to functionalized nonwovens having anionic groups covalently bonded at the surface, the production thereof and use thereof as filter materials, in particular for filtration of polymers such as proteins.

### BACKGROUND

Functionalization of substrates by using hydrophilizing materials is a technique that has for long been tried and tested.

Several wet chemical and/or photochemical processes are known from the related art in which substrates are functionalized at the surface with ethylenically unsaturated acids or bases. These methods involve the impregnation of substrates with polymerizable monomers and prior to that or afterwards, a treatment with UV, alpha, beta or gamma radiation, thermal treatment or treatment with ozone (optionally, after first hydrophilizing the surface by plasma treatment or corona treatment). Examples are described in U.S. Pat. No. 3,008,920, U.S. Pat. No. 3,070,573; WO-A-01/34,388 and U.S. Pat. No. 6,384,100. Surface layers produced in this way are usually relatively thick, i.e., they have a thickness in the range of micrometers.

EP-A-574,352 describes a surface treatment of polymer substrates by grafting using polymerizable monomers such as (meth)acrylic acid. After a plasma treatment, the surface is brought in contact with oxygen, thus forming hydroperoxide groups; grafting is then performed by contact with the polymerizable monomers. Surface layers produced in this way are also relatively thick.

A similar method which also yields relatively thick surface layers is known from KR-A-89-03,550. In this method, a fiber is treated with a low-pressure plasma, and subsequently a polymerizable monomer such as acrylic acid is applied.

KR-A-91-08,303 describes treatment of a fiber using a low-pressure plasma in the presence of a gaseous polymerizable monomer such as acrylic acid.

WO-A-00/69,548 describes the modification of a membrane surface by treatment with a glow discharge to which saturated alkane or acetylene is added. Possible additives include other comonomers such as acrylic acid. This publication describes different porous materials as substrates, mainly membranes. The functionalized membranes can be used for concentrating protein solutions.

EP-A-896,035 describes the production of surface coatings by gas phase polymerization or plasma polymerization of selected monomers. The method described here is used mainly for hydrophilizing contact lenses.

WO-A-03/84,682 describes a method for treating substrates with atmospheric plasma to which polymerizable organic acids and/or bases are added. Various substrates of different materials are described. The plasma treatment results in functionalized substrates suitable for use for filtration and separation methods. Functionalization of nonwovens or their use as filter materials or separation materials is not disclosed there.

WO-A-03/86,031 discloses a device for producing an atmospheric plasma for coating substrates.

### SUMMARY OF THE INVENTION

The present invention provides functionalized nonwovens characterized by an excellent separation effect in the filtration of polymer compounds, which have only small quantities of functionalizing material and may be manufactured by a simple, environmentally friendly method. Nonwovens according to the present invention have properties comparable to or even better than those of traditional substrates produced by wet chemical methods while containing much smaller amounts of functionalizing material.

A further or alternate object of the present invention is to provide nonwovens which are suitable as filter materials and have a high and permanent anionic surface charge.

A further or alternate object of the present invention is to provide filter materials that are excellent for use in protein filtration and constitute an alternative to the membrane filters traditionally used.

A further or alternate object of the present invention is to provide a solvent-free method for producing functionalized nonwovens.

The present invention relates to functionalized nonwovens which have a negative zeta potential in the pH range of 1 to 13 and in which the fibers have a surface layer applied by plasma treatment or have surface areas having groups covalently bonded to the fiber surface, selected from anionic groups and/or precursors convertible to anionic groups and/or polyether groups and/or polyol groups.

The fibers of the nonwoven according to the present invention preferably contain acids covalently bonded at the surface or their precursors, polyols or polyethers.

The surface layer of the fibers or individual layers on the fiber surface typically have layer thicknesses of no more than 100 nm, preferably layer thicknesses of 5 nm to 100 nm.

The surface layer or surface regions of the functionalized nonwovens according to the present invention are applied by a plasma treatment, one or more compounds and/or polyethers and/or polyols containing an organic radical and an anionic group and/or the precursors thereof, preferably at least one organic group and at least one acid group and/or compounds containing the precursors thereof, in particular ethylenically unsaturated acids and/or their precursors, being added to the plasma; instead of or together with the acids, their salts may also be used.

Compounds having groups that may be converted into acids by an aftertreatment after applying the surface layers or regions are the acid precursors. Examples include anhydrides, esters, amides, sulfoxides or sulfones. Mono-, di-, tri- or polyesters of polyols optionally containing one or more ether groups with carboxylic acids may also be used.

Compounds having multiple hydroxyl groups may be used as polyols. These may be low-molecular aliphatic or cycloaliphatic compounds such as ethylene glycol, propylene glycol, butylene glycol, trimethylolpropane, pentaerythritol or sorbitol or they may be higher molecular aliphatic or cycloaliphatic compounds such as polyethylene glycol, polypropylene glycol or polybutylene glycol of different degrees of polymerization.

Compounds having at least two ether groups may be used as the polyethers. They may be low-molecular-weight aliphatic or cycloaliphatic compounds such as ethylene glycol alkyl ether, propylene glycol alkyl ether or butylene glycol alkyl ether, trimethylolpropane alkyl ether, pentaerythritol, alkyl ether or sorbitol alkyl ether or they may be higher-molecular-weight compounds such as polyethylene glycol alkyl ether, polypropylene glycol alkyl ether or polybutylene glycol alkyl ether having different degrees of polymerization.

In addition, compounds having polyether groups and polyol groups may also be used.

The functionalization of substrates using preferably ethylenically unsaturated acids and plasma treatment is known per se and is described in WO-A-03/84,682 or WO-A-03/86,031.

The nonwovens required for the manufacture of the filter materials according to the present invention may be manufactured by any known methods by wet or dry processes or other processes.

For example, spun-bonded nonwoven methods, carding methods, melt-blowing methods, wet-laid nonwoven methods, electrostatic spinning or aerodynamic nonwoven manufacturing methods may be used.

The functionalized nonwovens according to the present invention may thus be spun-bonded nonwovens, melt-blown nonwovens, staple-fiber nonwovens, wet-laid nonwovens or hybrid media of these nonwovens such as melt-blown/wet-laid nonwovens or melt-blown/staple-fiber nonwovens.

The filter materials according to the present invention contain fibers of fiber-forming polymers and are preferably compacted.

The filter materials according to the present invention may be made of any types of fibers in a wide variety of diameter ranges. Typical fiber diameters vary in the range from 0.01 μm to 200 μm, preferably 0.05 μm to 50 μm.

In addition to continuous fibers, these fiber materials may also include or contain staple fibers.

In addition to homofilament fibers, it is also possible to use heterofilament fibers or mixtures of different types of fibers.

The nonwovens functionalized according to the present invention typically have a weight per unit surface of 0.05 g/m² to 500 g/m².

Functionalized nonwovens having a low weight per unit surface of 1 g/m² to 150 g/m² are particularly preferred for use.

A wide variety of polymers may be used as the fiber-forming polymers, depending on the intended application.

Examples of polymers include polyesters, in particular polyethylene terephthalate, polybutylene terephthalate or copolymers containing polyethylene terephthalate units or polybutylene terephthalate units, polyamides [nylons], in particular polyamides derived from aliphatic diamines and dicarboxylic acids, aliphatic aminocarboxylic acids or aliphatic lactams, or aramids, i.e., polyamides derived from aromatic diamines and dicarboxylic acid, polyvinyl alcohol, viscose, cellulose, polyolefins such as polyethylene or polypropylene, polysulfones such as polyethersulfone or polyphenylenesulfone, polyarylene sulfides such as polyphenylene sulfide, polycarbonate or mixtures of two or more of these polymers.

The nonwovens functionalized according to the present invention may be compacted in a known way, e.g., by mechanical or hydromechanical needling, by melting of bonding fibers present in the nonwoven, by thermomechanical compacting or by application of binders.

It has been found that the nonwovens functionalized according to the present invention can be manufactured by a plasma treatment. Therefore, thin layers or regions of materials that are covalently bonded at the surface are formed on the fibers of the nonwoven, these materials having groups that facilitate the development of a negative zeta potential. These are typically groups which have or are capable of forming covalently bonded anionic radicals or which have polarizable hydroxyl groups or ether groups. Examples of anionic radicals include acid groups, their salts, or acid precursors, the acid groups being produced from these precursors in downstream steps, e.g., by oxidation. The anionic groups at the surface or the polarizable hydroxyl groups or ether groups produce a high surface charge and result in the development of a pronounced double layer.

Examples of anionic radicals include radicals of sulfonic acids, in particular arylsulfonic acids, carboxylic acids, amino acids, sulfinic acids, xanthogenic acids, peracids, thiolic acids, dithiocarbamic acids and dithiocarboxylic acids, including the salts derived from these acids.

Nonwovens functionalized according to the present invention are characterized by a negative zeta potential over a wide pH range, typically between 1 and 13, preferably between 2 and 11. For the purposes of the present invention, the zeta potential is measured using a commercially available electrokinetic analyzer (EKA) from the company PAAR (Graz, Austria).

Functionalized nonwovens having a zeta potential of −1 mV to −100 mV, in particular from −5 mV to −80 mV in the pH range from 2 to 11 are preferred.

Other preferred functionalized nonwovens have a plateau of the negative zeta potential in the pH range from 5 to 11, in particular between −10 mV and −60 mV in the case of fibers having carboxyl groups and between −60 mV and −100 mV in the case of fibers having sulfonic acid groups.

The surface layers or regions produced according to the present invention are very stable and are not destroyed by treatment of the functionalized nonwovens in strongly alkaline media.

Nonwovens functionalized with acid groups or their precursors may be washed for 30 minutes at 40° C. in 0.5 M sodium hydroxide solution and then rinsed with water. Therefore, the corresponding sodium salts that promote the development of the double layer are formed from the acid groups that are covalently bound at the surface.

The stability of the plasma polyol layers thus produced may be further increased through special measures. Compounds having a crosslinking effect may be added to the plasma, or before the actual functionalization of the nonwovens; the substrate may be activated by plasma treatment without the addition of functionalizing substances, or functionalization may be performed several times, resulting in the development of multiple layers.

Any compounds having at least one organic radical and containing at least one, preferably two, acid groups or in particular one acid group, may be used.

In addition to carboxylic acids, it is also possible to use sulfonic acids or phosphoric acids as well as their salts, preferably their alkali salts, their anhydrides or other precursors that may be converted to acids, e.g., their esters or amides. In addition to acids having saturated organic radicals, preferably acids with ethylenically unsaturated radicals may be used. Examples of organic radicals include alkyl, alkenyl, alkynyl, cycloalkyl, cycloalkenyl, cycloalkynyl, aryl, heteroaryl and aralkyl radicals.

Preferred acids having ethylenically unsaturated radicals include ethylenically unsaturated carboxylic acids, ethylenically unsaturated sulfonic acids, ethylenically unsaturated phosphonic acids or phosphoric acid esters with ethylenically unsaturated alcohols.

Examples of ethylenically unsaturated carboxylic acids include acrylic acid, methacrylic acid, fumaric acid, maleic acid, citraconic acid, cinnamic acid or itaconic acid.

Examples of ethylenically unsaturated phosphonic acids include vinylphosphonic acid and vinylphenylphosphonic acid.

Examples of ethylenically unsaturated sulfonic acids include vinylsulfonic acid and vinylphenylsulfonic acid.

Instead of or in combination with ethylenically unsaturated acids or their derivatives, acid precursors, in particular ethylenically unsaturated acid precursors, may be initially deposited on the fiber surface and then converted to the corresponding acids in a subsequent step.

Examples include sulfones or sulfoxides, preferably ethylenically unsaturated sulfones or sulfoxides, as well as carboxylic acid esters, carboxylic acid amides, phosphoric acid esters, phosphoric acid amides, sulfonic acid esters or sulfonamides.

Preferred ethylenically unsaturated sulfones or sulfoxides include vinylsulfone, divinylsulfone, vinyl sulfoxide and divinyl sulfoxide.

Preferred carboxylic acid esters include polyalkylene glycol mono- or diacrylate or polyalkylene glycol mono- or dimethacrylate.

After covalent bonding to the fiber surface by oxidation, sulfonic acid groups bound at the surface may be released from these compounds.

The development of double layers in combination with the pore structure of the nonwoven results in an extremely efficient filtration effect, in particular of substrates having ionic groups, e.g., proteins, amino acids or other polymers functionalized with ionic groups.

In the functionalization of fibers according to the present invention, only small quantities of anionic groups and/or their precursors are deposited on the fiber surface in comparison with traditional wet chemical methods. This is manifested in a small thickness of the layers or regions of anionic groups deposited on the fibers. The thicknesses of these layers or regions usually vary in the range given above and are determinable by X-ray photoelectron spectroscopy, for example. Layer thicknesses of up to 100 nm may be determined, corresponding to the theoretical depth of information of this surface analysis method. Larger layer thicknesses may be determined by AFM, ellipsometry, or REM.

It is self-evident here that the nonwovens functionalized according to the present invention may also have small portions, e.g., up to 10 vol %, e.g., in the interior of the plasma-treated functionalized nonwovens in which fibers occur without layers or regions of anionic groups.

Preferably, however, all fibers of the nonwovens functionalized according to the present invention have surface layers or regions having anionic groups or polarizable ether groups and/or hydroxyl groups.

The method according to the present invention is characterized by a low material and power consumption and, since it is a solvent-free process, it is also environmentally friendly.

The present invention also relates to methods for producing the functionalized nonwoven defined above, including the steps:
a) production of a nonwoven by an essentially known nonwoven-forming technique,
b) providing an area in space in which a plasma discharge is burning and in which at least one acid containing an organic radical and/or the salt and/or precursor thereof and/or a polyether and/or a polyol, preferably at least one ethylenically unsaturated acid or the salt, anhydride and/or precursor thereof is present in a finely divided form and
c) transport of the nonwoven through the area in space in which the plasma discharge is burning so that the nonwoven is exposed to the plasma discharge.

In an alternative embodiment, the method according to the present invention relates to the production of the functionalized nonwoven defined above, including the steps:
a) production of a nonwoven by an essentially known nonwoven-forming technique,
b) providing an area in space in which a plasma discharge is burning and in which at least one precursor of an acid containing an organic radical is present in a finely divided form, optionally in combination with at least one acid containing an organic radical, the salt and/or precursor thereof and/or a polyether and/or a polyol,
c) transport of the nonwoven through the area in space in which the plasma discharge is burning so that the nonwoven is exposed to the plasma discharge, and
d) aftertreatment of the functionalized nonwoven using an agent to produce the acid or the salt thereof from the precursor of the acid.

The plasma treatment is performed by continuously passing the nonwoven through the plasma discharge. Typical web speeds amount to 0.5 m/min to 400 m/min.

According to the present invention, a plasma that burns at atmospheric pressure as described in WO-A-03/84,682 or WO-A-03/86,031 is used as the plasma. Under the conditions of the plasma treatment, the compound having one organic radical and at least one anionic group is activated while retaining its structure and may in this way be covalently bonded to the fiber surface on coming in contact with the latter.

The treatment is performed in an oxidizing atmosphere or preferably in a non-oxidizing atmosphere using, for example, a noble gas such as helium or argon as the inert gas together with the compound containing an organic radical and at least one anionic group and/or the precursor or derivative thereof at atmospheric pressure. The addition of other reactive gases or additives to the plasma may be omitted. Typical operating pressures in the plasma are 0.7 bar to 1.3 bar, preferably 0.9 bar to 1.1 bar.

The aftertreatment of the nonwoven functionalized using the precursor of an acid is typically performed by oxidation of the fiber surface modified by the plasma treatment. This may be accomplished by using oxidizing agents, e.g., in the gas phase or by a wet chemical process or by aftertreatment using an oxidizing plasma.

In preferred variants of the processes defined above, crosslinking agents having at least two reactive groups, preferably ethylenically unsaturated groups, particularly preferably at least two vinyl groups, are added to the plasma.

Other preferred variants of the processes defined above include activation of the substrate by plasma treatment in an inert gas atmosphere or with air before the actual plasma treatment.

Other preferred variants of the processes defined above include multiple plasma treatments, resulting in the development of multilayers.

Nonwovens functionalized according to the present invention are preferably used in filter processes or separation processes in gaseous media or in particular in liquid media. The nonwovens functionalized according to the present invention are used as filter media or they are combined with membranes for use as prefilters.

Nonwovens functionalized according to the present invention may be used as media or prefilters in water or food filtration or for filtration of pharmaceuticals. However, they may also be used as media or prefilters for fuel filtration, for oil filtration or for lubricant filtration or as filter media or separation media for respiratory protection, in air conditioning systems, for internal combustion engines, electric motors or industrial plants or in dust removal systems.

Nonwovens functionalized according to the present invention are preferably used for filtration or separation of solvent constituents, in particular ionized or ionizable chemical compounds, preferably ionized or ionizable polymers such as proteins.

The present invention also relates to the use of functionalized nonwovens as filter materials or separation materials.

### BRIEF DESCRIPTION OF THE DRAWINGS

The present invention is described below with reference to the drawings, in which:

FIG. 1 shows zeta potentials for the functional nonwovens described in Example 1 and the untreated starting material;

FIG. 2 shows zeta potentials of the functionalized nonwovens described in Examples 5 and 6 as well as the untreated starting material; and

FIG. 3 shows zeta potentials of the functionalized nonwoven described in Example 8, treated by one or two plasma treatments as well as the untreated starting material.

### DETAILED DESCRIPTION

The following examples describe the present invention without limiting it.

### EXAMPLE 1

A nonwoven made of polypropylene (PP) and polyethylene (PE) fibers was functionalized under the effect of an atmospheric pressure plasma. Helium was used as the inert gas and acrylic acid as the reactive substance. During the plasma treatment, the process was carried out in the absence of oxygen. The nonwoven samples had a negative zeta potential over the entire pH range. The acid group content at the surface was determined by adjusting a pH range around 11 and by back titration with 0.01 N hydrochloric acid. A carboxyl group content of 0.12 mmol/g nonwoven was found.

### EXAMPLE 2

A nonwoven made of PP/PE fibers was functionalized as described in Example 1 except that divinyl sulfoxide was used instead of acrylic acid. After the plasma treatment with divinyl sulfoxide, the modified nonwoven was oxidized by treatment with an oxygen-containing plasma (mixture of He+O₂). The nonwoven samples had a negative zeta potential over the entire pH range. An acid group content of 0.06 mmol/g nonwoven was found.

### EXAMPLE 3

A nonwoven made of PP/PE fibers was functionalized as described in Example 2 and then oxidized with oxygen-containing plasma except that instead of divinyl sulfoxide, phenylvinyl sulfoxide was used. The nonwoven samples had a negative zeta potential over the entire pH range.

### EXAMPLE 4

A nonwoven made of PP/PE fibers was functionalized under the effect of an atmospheric pressure plasma. Helium was used as the inert gas; acrylic acid was used as the reactive substance in the first step, and phenylvinyl sulfoxide was used as the reactive substance in the second step. During the two steps of the plasma treatment, the process was carried out in the absence of oxygen. The material was then oxidized in an oxygen-containing plasma. The nonwoven samples had a negative zeta potential over the entire pH range.

### EXAMPLE 5

A nonwoven made of PP/PE fibers was functionalized as described in Example 4, except that in the second step divinyl sulfoxide was used instead of phenylvinyl sulfoxide. The nonwoven samples had a negative zeta potential over the entire pH range.

### EXAMPLE 6

A nonwoven made of PP/PE fibers was functionalized as described in Example 4, except that before performing the second step the acrylic acid layer was oxidized with an oxygen-containing plasma. Divinyl sulfoxide was then deposited in a helium plasma and this layer was then oxidized in an oxygen-containing plasma. The nonwoven samples had a negative zeta potential over the entire pH range. An acid group content of 0.016 mmol/g nonwoven was found.

### EXAMPLE 7

A nonwoven made of PP/PE fibers was functionalized as described in Example 6, except that, after oxidation of the acrylic acid layer in the He plasma, phenylvinyl sulfoxide was deposited instead of divinyl sulfoxide. The nonwoven samples had a negative zeta potential over the entire pH range.

### EXAMPLE 8

A nonwoven made of PP/PE fibers was functionalized as described in Example 1, except that instead of acrylic acid, polyethylene glycol methacrylate was used. The nonwoven samples had a negative zeta potential over the entire pH range.

Characterization of the Functionalized Nonwovens

Various nonwovens were characterized by XPS spectroscopy and by elemental analysis. The measurements were performed using a Kratos Analytical Axis Ultra instrument in the monochromated Al Kα X-rays mode. The following spectra were recorded: O 1s, N 1s, C 1s, S 2p and Si 2p. Table 1 below summarizes the XPS—C (1s) spectra, showing the amount of C (1s) per functional group.

TABLE 1

| | C—C | C—O | C═O | COOC | COOH |
|---|---|---|---|---|---|
| Type of nonwoven | (%) | (%) | (%) | (%) | (%) |
| PP/PE untreated | 93.9 | 3.4 | 0.7 | 2.0 | 0 |
| Example 1 | 69.0 | 5.7 | 2.1 | 3.1 | 20.1 |
| Example 1, washed in NaOH | 85.7 | 5.5 | 1.0 | 7.8 | 0 |
| Example 1, washed in boiling | 82.2 | 13.1 | 1.4 | 1.4 | 1.9 |
| water | | | | | |

Table 2 below summarizes the results of XPS elemental analysis of different nonwovens.

TABLE 2

| Type of | | | | | | |
|---|---|---|---|---|---|---|
| nonwoven | Na (%) | O (%) | C (%) | N (%) | S (%) | Si (%) |
| PP/PE | 0 | 7.3 | 92.7 | n.d. | n.d. | n.d. |
| untreated | | | | | | |
| Example 1 | 0 | 30.1 | 69.8 | n.d. | n.d. | n.d. |
| Example 1, | 5.0 | 17.4 | 77.6 | n.d. | n.d. | n.d. |
| washed in NaOH | | | | | | |
| Example 1, | 0 | 10.4 | 89.6 | n.d. | n.d. | n.d. |
| washed in | | | | | | |
| boiling water | | | | | | |
| Example 2 | n.d. | 21.0 | 73.1 | 1.3 | 2.9 | 1.8 |
| Example 2, | n.d. | 13.5 | 82.5 | 0.8 | 2.8 | 0.4 |
| washed in NaOH | | | | | | |
| Example 6 | n.d. | 27.6 | 64.4 | 1.3 | 3.4 | 3.4 |
| Example 6, | n.d. | 12.0 | 85.3 | 0.3 | 0.9 | 1.5 |
| washed in NaOH | | | | | | |
| Example 3 | n.d. | 26.3 | 70.6 | n.d. | 3.1 | n.d. |
| Example 7 | n.d. | 30.3 | 59.1 | 2.6 | 4.0 | 3.7 |
| Example 7, | n.d. | 11.7 | 85.9 | 0.3 | 1.2 | 1.0 |
| washed in NaOH | | | | | | |

n.d. = not determined

Table 3 below shows the results of analysis of the XPS—S (2s) spectra with the proportion of S (2p) per functional group after washing the samples for 30 minutes in 0.5 M NaOH at 40° C.

TABLE 3

| | | | | | | Sulfonate | Sulfonate |
|---|---|---|---|---|---|---|---|
| | | | | | | (after | (before |
| Type of | C—C—S | C—S═O | O═S═O | O═S(O)═O | O═S(═O)═O | washing) | washing) |
| nonwoven | (%) | (%) | (%) | (%) | (%) | (%) | (%) |
| Example 2 | 70.0 | 11.2 | 3.1 | 15.8 | n.d. | 15.8 | 67 |
| Example 6 | 33.3 | 11.4 | n.d. | 25.1 | 30.3 | 55.4 | 66 |
| Example 5 | 45.9 | 12.7 | n.d. | 24.8 | 16.6 | 41.4 | 83 |
| Example 7 | 31.5 | 38.3 | 7.0 | 23.2 | n.d. | 23.2 | 81 |
| Example 4 | 23.6 | 19.8 | n.d. | 31.8 | 24.8 | 56.6 | 77 |

n.d. = not determined

The figures show zeta potentials for the functionalized nonwovens described in Examples 1, 5, 6 and 8 at different pH values.

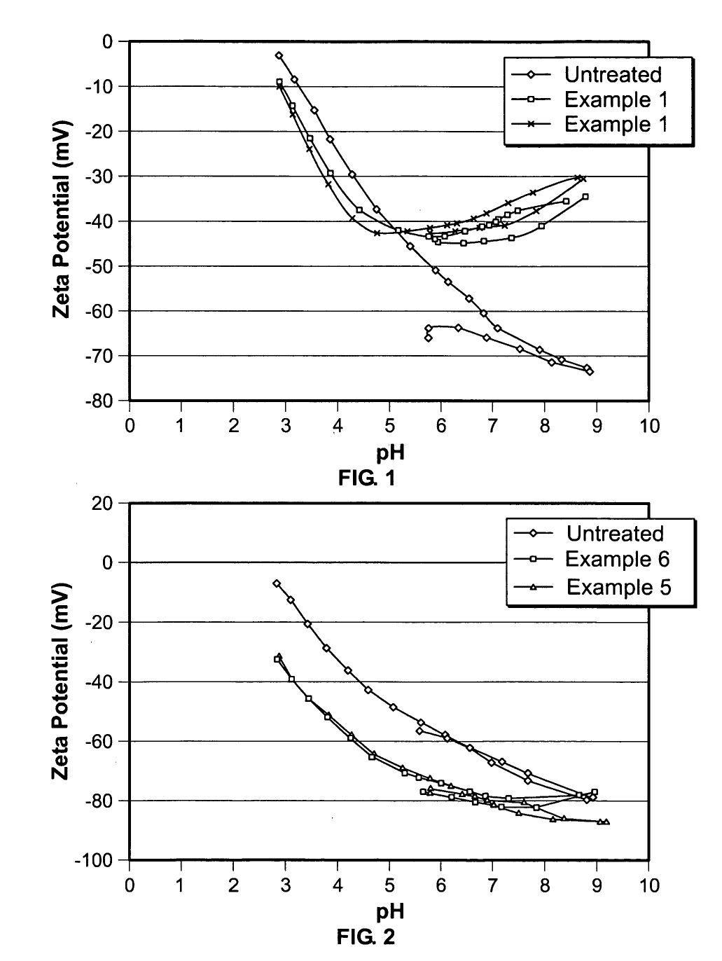

FIG. 1 shows zeta potentials of the functionalized nonwoven described in Example 1 and the untreated starting material. This shows that the functionalization at a pH between 3 and 5 results in a more negative zeta potential in comparison with the starting material; this also shows that a negative zeta potential plateau develops in the pH range 5 to 9 with this functionalized nonwoven, whereas the untreated starting material has a more negative zeta potential in this pH range. The zeta potential plateau proves the successful functionalization of the surface of the nonwoven. Due to the fact that the zeta potential remains uniform over a wide pH range, the target component may be adsorbed or desorbed in a controlled manner during use as a result of shifts in pH as a function of its isoelectric point.

FIG. 2 shows zeta potentials of the functionalized nonwovens described in Examples 5 and 6 as well as the untreated starting material. This shows that functionalization results in a drop in the zeta potential over the entire pH range.

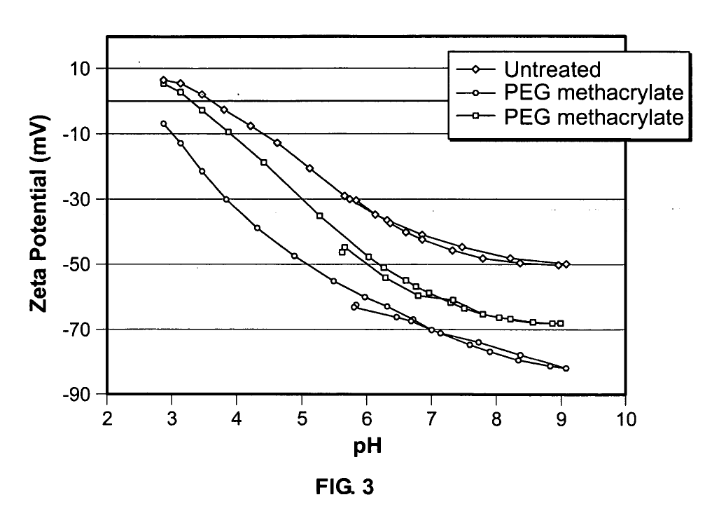

FIG. 3 shows that functionalization results in a decline in zeta potential over the entire pH range. The effect is more pronounced in the nonwoven that was plasma treated twice than in the nonwoven after a single plasma treatment.

What is claimed is:

1. A functionalized nonwoven, comprising:
fibers having a surface layer or a surface region applied by a plasma treatment; and
groups covalently bonded at the fiber surface, wherein the groups are selected from the group consisting of: anionic groups, precursors convertible into anionic groups, polyether groups, and polyol groups,
wherein the functionalized nonwoven has a negative zeta potential in a pH range from 1 to 13.

2. The functionalized nonwoven as recited in claim 1, wherein the groups are include at least one of anionic groups and precursors convertible into anionic groups.

3. The functionalized nonwoven as recited in claim 1, wherein the surface layer or surface region has a thickness of no more than 100 nm.

4. The functionalized nonwoven as recited in claim 3, wherein the thickness of 5 nm to 1100 nm.

5. The functionalized nonwovens as recited in claim 1, wherein the groups include acids and/or their salts covalently bonded to the fiber surface.

6. The functionalized nonwoven as recited in claim 1, wherein the functionalized nonwoven includes at least one material selected from the group consisting of a spun-bonded nonwoven, a melt-blown nonwoven, a staple-fiber nonwoven, a wet-laid nonwoven, and a hybrid media of these nonwovens.

7. The functionalized nonwoven as recited in claim 1, wherein the fibers include one or more fibers selected from the group consisting of polyamide fibers, polyester fibers, aramid fibers, polyvinyl alcohol fibers, viscose fibers, cellulose fibers, polyolefin fibers, polyethylene fibers, polypropylene fibers, polysulfone fibers, polyethersulfone fibers, polyphenylenesulfone fibers, polyarylene sulfide fibers, polyphenylene sulfide fibers, and polycarbonate fibers.

8. The functionalized nonwovens as recited in claim 1, wherein the fibers have a zeta potential of −1 mV to −100 mV in the pH range from 2 to 11.

9. The functionalized nonwovens as recited in claim 8, wherein the fibers have a zeta potential of −5 mV to −80 mV.

10. The functionalized nonwovens as recited in claim 8, wherein the fibers have carboxyl groups and a negative zeta potential plateau between −10 mV to −60 mV in the pH range from 5 to 11.

11. The functionalized nonwovens as recited in claim 8, wherein the fibers have sulfonic acid groups and a zeta potential between −60 mV and −100 mV.

12. The functionalized nonwovens as recited in claim 1, wherein the groups include acid groups covalently bonded to the fiber surface, wherein the acid groups are derived from at least one of carboxylic acids, sulfonic acids, phosphoric acids, and compounds containing their salts or anhydrides.

13. The functionalized nonwovens as recited in claim 12, wherein the carboxylic acids, sulfonic acids and/or phosphoric acids have at least one ethylenically unsaturated radical.

14. The functionalized nonwovens as recited in claim 13, wherein the carboxylic acids include at least one acid selected from the group consisting of acrylic acid, methacrylic acid, fumaric acid, maleic acid, citraconic acid, cinnamic acid, and itaconic acid.

15. The functionalized nonwovens as recited in claim 12, wherein the phosphoric acids include ethylenically unsaturated phosphonic acids.

16. The functionalized nonwovens as recited in claim 15, wherein the unsaturated phosphonic acids include at least one of vinylphosphonic acid and vinylphenylphosphonic acid.

17. The functionalized nonwovens as recited in claim 12, wherein the sulfonic acids include ethylenically unsaturated sulfonic acids.

18. The functionalized nonwovens as recited in claim 17, wherein the ethylenically unsaturated sulfonic acids include at least one of vinylsulfonic acid and vinylphenylsulfonic acid.

19. The functionalized nonwovens as recited in claim 1, wherein the groups include acid precursors covalently bonded to the fiber surface.

20. The functionalized nonwovens as recited in claim 19, wherein the acid precursors are ethylenically unsaturated acid precursors selected from the group consisting of ethylenically unsaturated sulfones, ethylenically unsaturated sulfoxides, and combinations thereof.

21. The functionalized nonwovens as recited in claim 20, wherein the ethylenically unsaturated sulfones include one of vinylsulfone and divinylsulfone and wherein the ethylenically unsaturated sulfoxides include one of vinyl sulfoxide and divinyl sulfoxide.

22. The functionalized nonwovens as recited in claim 1, wherein the groups include polyol groups derived from one of ethylene glycol, propylene glycol, butylene glycol, trimethylolpropane, pentaerythritol, sorbitol, polyethylene glycol, polypropylene glycol and polybutylene glycol.

23. The functionalized nonwovens as recited in claim 1, wherein the groups include polyether groups derived from one of ethylene glycol ether, propylene glycol ether, butylene glycol alkyl ether, trimethylolpropane alkyl ether, pentaerythritol alkyl ether, sorbitol alkyl ether, polyethylene glycol ether, polypropylene glycol ether and polybutylene glycol alkyl ether.

24. A method for producing a functionalized nonwoven, the method comprising:
a) providing a nonwoven;
b) providing an area in space in which a plasma discharge is burning and in which is disposed in finely divided form at least one acid containing at least one of an organic radical, a salt, a precursor of the organic radical, a polyether, a polyol, at least one ethylenically unsaturated acid, a salt, anhydride or precursor thereof; and
c) transporting the nonwoven through the area in space so as to expose the nonwoven to the plasma discharge.

25. The method for producing a functionalized nonwoven, the method comprising:
a) providing a nonwoven;
b) providing an area in space in which a plasma discharge is burning and in which is disposed in finely divided form at least one precursor of an acid containing an organic radical, optionally in combination with at least one acid containing an organic radical, the salt thereof and/or the precursor thereof and/or a polyether and/or a polyol;
c) transporting the nonwoven through the area in space so as to expose the nonwoven to the plasma discharge; and
d) performing an aftertreatment of the functionalized nonwoven using a means for creating the acid or salt thereof from the precursor of the acid.

26. The method as recited in claim 24, wherein the burning of the plasma discharge is performed at pressures between 0.7 bar and 1.3 bar and in a non-oxidizing atmosphere.

27. The method as recited in claim 24, further comprising adding crosslinking agents having at least two reactive groups to the plasma.

28. The method as recited in claim 27, wherein the at least to reactive groups include ethylenically unsaturated groups.

29. The method as recited in claim 28 wherein the ethylenically unsaturated groups include at least two vinyl groups.

30. The method as recited in claim 24, further comprising activating the nonwoven by plasma treatment in an inert gas atmosphere or with air before step b).

31. The method as recited in claim 24, further comprising repeating step b) several times.

32. The functionalized nonwoven as recited in claim 1, wherein the functionalized nonwoven forms at least a portion of one of a filter and a separation material.

33. The functionalized nonwoven as recited in claim 32, wherein the filter or separation material is configured for use in a liquid media.

34. The functionalized nonwoven as recited in claim 32, wherein filter or separation material is configured for filtration or separation of ionized or ionizable polymers.
